(19) United States
(12) Patent Application Publication
(10) Pub. No.: US 2016/0225174 A1
(43) Pub. Date: Aug. 4, 2016

(54) IMAGE PROCESSING APPARATUS, IMAGE PROCESSING SYSTEM, AND RECORDING MEDIUM STORING AN IMAGE PROCESSING PROGRAM

(71) Applicant: Shinji AOKI, Kanagawa (JP)

(72) Inventor: Shinji AOKI, Kanagawa (JP)

(21) Appl. No.: 14/995,225

(22) Filed: Jan. 14, 2016

(30) Foreign Application Priority Data
Jan. 30, 2015 (JP) 2015-017182

(51) Int. Cl. G06T 11/60; H04N 19/423; H04N 19/42; H04N 19/44

(52) U.S. Cl. CPC G06T 11/60; H04N 19/44; H04N 19/423; H04N 19/42

(57) ABSTRACT

An image processing apparatus includes an encoded image data acquisition unit that acquires encoded image data, an image data decoder that decodes the encoded image data, a decoded image storage controller that stores the decoded image data in a memory, an image accessory information acquisition unit that acquires image accessory information including an integrated position where a first image data stored in the memory is integrated with a second image data acquired and decoded after the first image data is acquired, a synthetic method selector that selects a synthetic method to integrate the first image data with the second image data based on the acquired image accessory information and an alignment restriction of the image data decoder, and an image data synthesizer that integrates the first image data with the second image data in the memory using the selected synthetic method.

### CROSS-REFERENCE TO RELATED APPLICATION

This patent application is based on and claims priority pursuant to 35 U.S.C. §119(a) to Japanese Patent Application No. 2015-017182, filed on Jan. 30, 2015 in the Japan Patent Office, the entire disclosure of which is hereby incorporated by reference herein.

### BACKGROUND

1. Technical Field

The present invention relates to an image processing apparatus, an image processing system, and a non-transitory recording medium storing an image processing program.

2. Background Art

Image processing apparatuses such as projectors that displays images by projecting those images on a projection surface such as a screen in accordance with image data input from information processing apparatuses such as personal computers (PCs), smartphones, and tablet devices and displays that displays images on a liquid crystal panel are known.

When information processing apparatuses instruct the image processing apparatuses described above to display images, those information processing apparatuses do not transfer entire image data to the image processing apparatuses every time images change. Instead, those information processing apparatuses transfer the entire image data for the first time only. Subsequently, those information processing apparatuses transfer difference image data only for changed parts. Accordingly, image processing apparatuses display superimposed images by integrating the difference image data input from the information processing apparatuses with the entire image data input preliminarily.

### SUMMARY

Example embodiments of the present invention provide a novel image processing apparatus that includes an encoded image data acquisition unit that acquires encoded image data, an image data decoder that decodes the encoded image data, a decoded image storage controller that stores the decoded image data in a memory, an image accessory information acquisition unit that acquires image accessory information including an integrated position where a first image data stored in the memory is integrated with a second image data acquired and decoded after the first image data is acquired, a synthetic method selector that selects a synthetic method to integrate the first image data with the second image data based on the acquired image accessory information and an alignment restriction of the image data decoder, and an image data synthesizer that integrates the first image data with the second image data in the memory using the selected synthetic method.

Further example embodiments of the present invention provide an image processing system and a non-transitory recording medium storing an image processing program.

### BRIEF DESCRIPTION OF THE DRAWINGS

A more complete appreciation of the disclosure and many of the attendant advantages thereof will be readily obtained as the same becomes better understood by reference to the following detailed description when considered in conjunction with the accompanying drawings.

FIG. 1 is a diagram illustrating an image processing system as an embodiment of the present invention.

FIG. 2 is a block diagram illustrating a hardware configuration of an image processing apparatus as an embodiment of the present invention.

FIG. 3 is a block diagram illustrating a functional configuration of the image processing apparatus as an embodiment of the present invention.

FIG. 4 is a block diagram illustrating a functional configuration of the information processing apparatus as an embodiment of the present invention.

FIG. 5 is a sequence diagram illustrating operation that an image decoder writes image data in a memory as an embodiment of the present invention.

FIG. 6 is a diagram illustrating a data structure of the image data in the memory that the image decoder writes as an embodiment of the present invention.

FIG. 7 is a sequence diagram illustrating operation that the image processing apparatus synthesizes the image data using a direct write-in synthesis as an embodiment of the present invention.

FIG. 8 is a sequence diagram illustrating operation that the image processing apparatus synthesizes the image data using a simple synthesis as an embodiment of the present invention.

FIG. 9 is a sequence diagram illustrating operation that the image processing apparatus synthesizes the image data using a backup synthesis as an embodiment of the present invention.

FIG. 10 is a flowchart illustrating operation that the image processing apparatus selects a synthesizing method as an embodiment of the present invention.

FIG. 11 is a block diagram illustrating a functional configuration of the image processing apparatus as an embodiment of the present invention.

### DETAILED DESCRIPTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

In the existing technologies, in case of performing a synthesizing process under control of software, the image processing apparatuses cannot perform the process at high speed, and processing load gets heavy. By contrast, in the existing technologies, in case of performing a synthesizing process controlled by hardware, while the image processing apparatuses can perform the process at high speed, it is difficult to perform synthesis appropriately due to hardware restriction in some cases.

In the embodiments described below, an image processing apparatus that can perform synthesis of image data with light load at high speed and synthesize the image data appropriately is provided.

### Embodiment 1

An embodiment 1 is described below in detail with reference to figures.

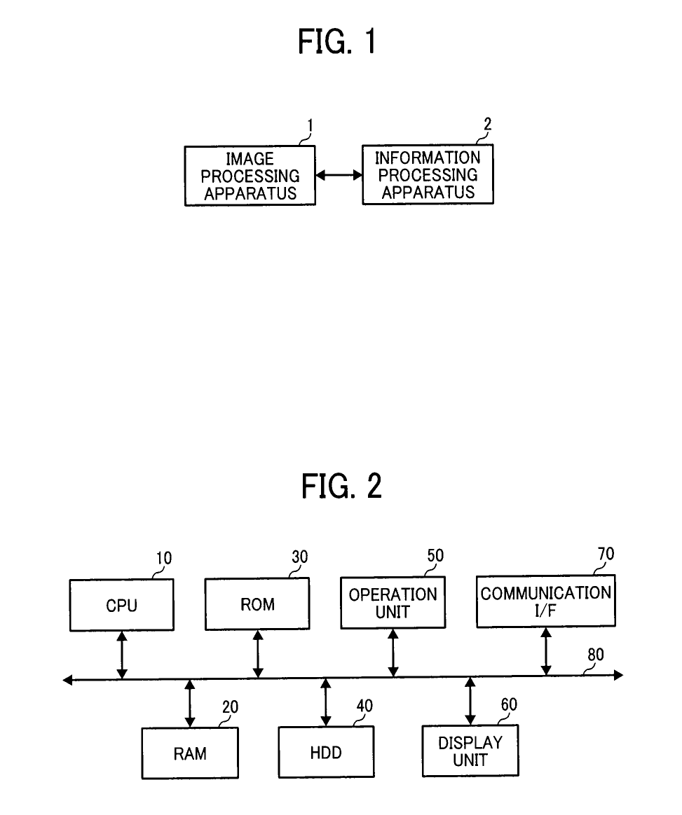

First, operation of an image processing system in this embodiment is described below with reference to FIG. 1. FIG. 1 is a diagram illustrating an image processing system in this embodiment.

As shown in FIG. 1, the image processing system includes an image processing apparatus 1 and an information processing apparatus 2 connected with each other.

Examples of the image processing apparatus 1 are a projector that displays an image by projecting the image on a projection surface such as a screen in accordance with image data input from the information processing apparatus 2 and a display that displays an image on a liquid crystal panel.

The information processing apparatus 2 is an information processing terminal for instructing the image processing apparatus 1 to display an image by user operation and transfers image data to the image processing apparatus 1. The information processing apparatus 2 in this embodiment is implemented by an information processing terminal such as a PC, a personal digital assistant (PDA), a smartphone, and a tablet device etc.

When the information processing apparatus 2 instructs the image processing apparatus 1 to display an image, the information processing apparatus 2 does not transfer entire image data to the image processing apparatus 1 every time the image changes. Instead, the information processing apparatuses 2 transfers the entire image data for the first time only. Subsequently, the information processing apparatus 2 transfers difference image data only for changed parts. Accordingly, the image processing apparatus 1 displays a superimposed image by integrating the difference image data input from the information processing apparatus 2 with the entire image data input preliminarily.

Next, a functional configuration of the image processing apparatus 1 in this embodiment is described below with reference to FIG. 2. FIG. 2 is a block diagram illustrating a hardware configuration of an image processing apparatus 1 in this embodiment. In FIG. 2, a hardware configuration of the image processing apparatus 1 is described as an example. However, much the same is true on the case of the information processing apparatus 2.

As shown in FIG. 2, the image processing apparatus 1 in this embodiment includes a central processing unit (CPU) 10, a random access memory (RAM) 20, a read only memory (ROM) 30, a hard disk drive (HDD) 40, a control panel 50, a display unit 60, and a communication I/F 70 connected with each other via a bus 80.

The CPU 10 is a processor and controls the whole operation of the image processing apparatus 1. The RAM 20 is a volatile storage device that can read/write information at high speed and is used as a work area when the CPU 10 processes information. The ROM 30 is a read-only non-volatile storage medium and stores programs such as firmware.

The HDD 40 is a nonvolatile storage medium that can read/write data and stores various data such as image data, an operating system (OS), and various programs such as application programs (e.g., various control programs and image processing programs).

The control panel 50 is a user interface to input data to the image processing apparatus 1 and is implemented by input devices such as a keyboard, a mouse, a touch panel, a switch, and a button etc.

The display unit 60 is a visual user interface for checking a status of the image processing apparatus 1 and implemented by a display device such as a liquid crystal display (LCD) etc.

The I/F 70 is an interface that the image processing apparatus 1 communicate with another apparatus, and interfaces such as Ethernet, a Universal Serial Bus (USB) interface, and a Peripheral Component Interconnect express (PCIe) interface etc. are used for the I/F 70.

In this hardware configuration described above, programs stored in storage devices such as the ROM 30 and HDD 40 are read to the RAM 20, and a software controlling unit is constructed by executing operation in accordance with the loaded programs by the CPU 10. Functional blocks that implement capabilities of the image processing apparatus 1 of this embodiment are constructed by a combination of the software controlling units described above and hardware.

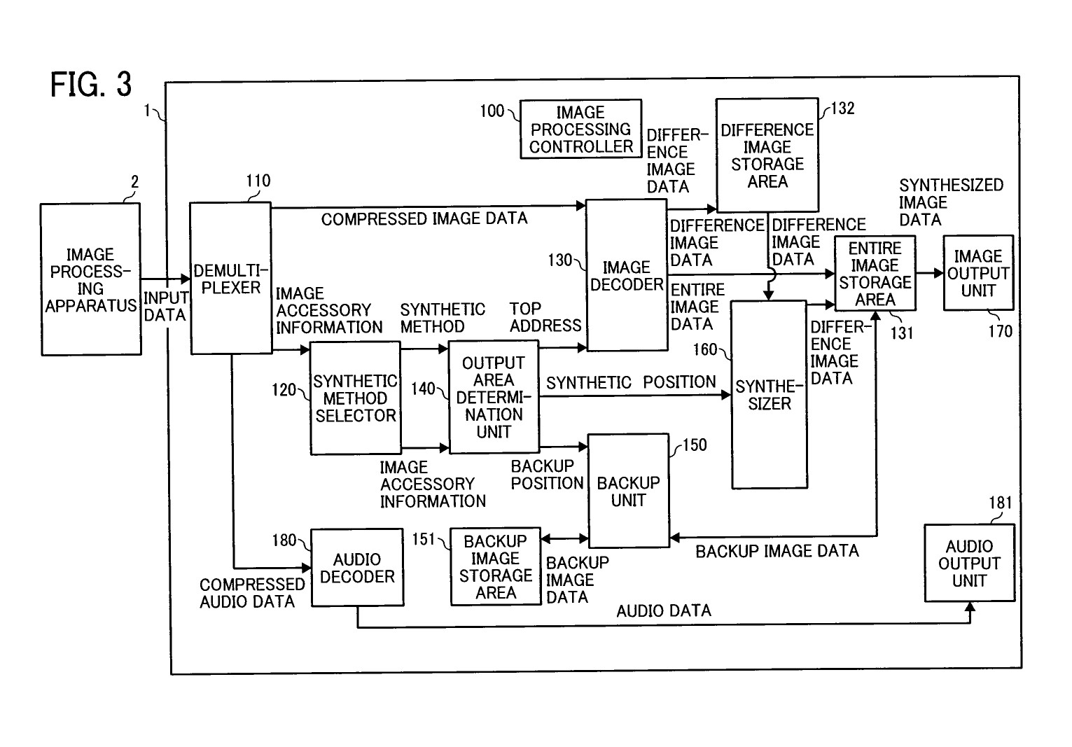

Next, a functional configuration of the image processing apparatus 1 in this embodiment is described below with reference to FIG. 3. FIG. 3 is a block diagram illustrating a functional configuration of the image processing apparatus 1.

As shown in FIG. 3, the image processing apparatus 1 in this embodiment includes an image processing controller 100, a demultiplexer 110, a synthetic method selector 120, an image decoder 130, an entire image storage area 131, a difference image storage area 132, an output area determination unit (determining unit) 140, a backup unit 150, a backup image storage area 151, a synthesizer 160, an image output unit 170, an audio decoder 180, and an audio output unit 181.

The image processing controller 100 controls various units included in the image processing apparatus 1 and gives commands to those units included in the image processing apparatus 1.

The demultiplexer 110 demultiplexes input data input from the information processing apparatus 2 to separate the input data into compressed image data, image accessory information, and compressed audio data. That is, in this embodiment, the demultiplexer 110 functions as an encoded image data acquisition unit and an image accessory information acquisition unit.

The demultiplexer 110 outputs the image accessory information to the synthetic method selector 120, outputs the compressed image data to the image decoder 130, and outputs the compressed audio data to the audio decoder 180 respectively.

Here, the image accessory information includes an integrated position where the difference image data is integrated with the entire image data, vertical resolution of the difference image data (referred to as “vertical resolution” hereinafter), and horizontal resolution of the difference image data (referred to as “horizontal resolution” hereinafter). In this embodiment, the vertical direction and the horizontal direction are orthogonal with each other. That is, in this embodiment, at least any one of the vertical resolution and the horizontal resolution is included in the image accessory information as a component.

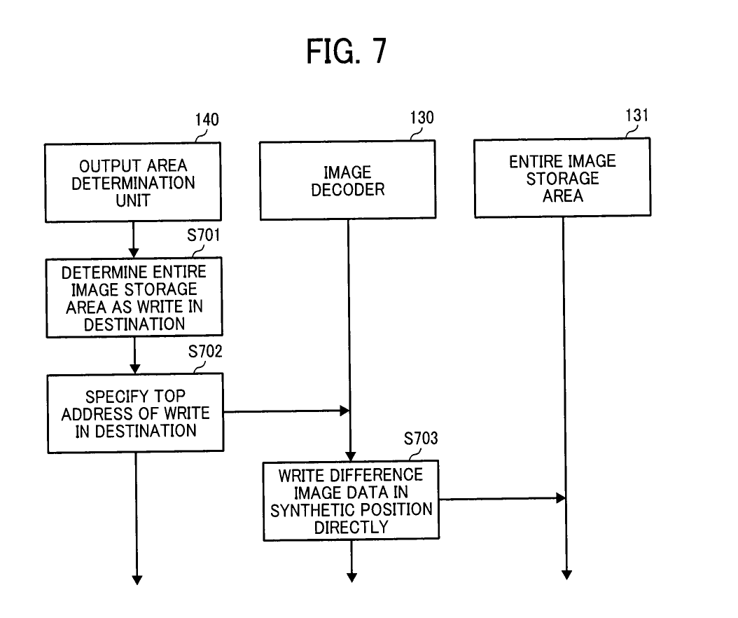

The synthetic method selector 120 selects a method of superimposing the difference image data on the entire image data. In this embodiment, there are three superimposing method, a direct write-in synthesis, a simple synthesis, and a backup synthesis. These superimposing methods are described later in detail with reference to FIGS. 7 to 9.

The image decoder 130 is a hardware decoder and decodes the compressed image data input from the demultiplexer 110. Subsequently, if the decoded result is the entire image data, the image decoder 130 writes the entire image data in the entire image storage area 131. By contrast, if the decoded result is the difference image data, the image decoder 130 writes the difference image data in the difference image storage area 132. That is, in this embodiment, the image decoder 130 functions as an image data decoder and a decoded image storage controller. The image processing controller 100 controls switching the writing destination of the image decoder 130.

In addition, if the synthetic method selector 120 selects the direct write-in synthesis as the synthetic method, the image decoder 130 generates superimposed image data by writing the difference image data at the integrated position in the entire image area. That is, in this case, the image decoder 130 functions as an image data synthesizer. Here, the entire image area is a memory area where the entire image data is stored in the entire image storage area 131.

The entire image storage area 131 is a memory area allocated in a memory and allocated for storing the entire image data written by the image decoder 130.

The difference image storage area 132 is a memory area allocated in a memory and allocated for storing the difference image data written by the image decoder 130.

The output area determination unit 140 determines whether the difference image data decoded by the image decoder 130 is written in the entire image storage area 131 or in the difference image storage area 132 and determines a top address of the memory area as a destination where the difference image data is written.

If the synthetic method selector 120 selects the backup synthesis as the synthesizing method, the backup unit 150 a part of the entire image data stored in the entire image storage area 131 to the backup image storage area 151 as backup image data. That is, in this embodiment, the backup unit 150 functions as a partial image storage controller.

Next, after the image decoder 130 writes the difference image data at the integrated position in the entire image area, the backup unit 150 writes back backup image data in the entire image data under control of software. In this case, the portion copied from the entire image data as the backup image data is described in detail later.

The backup image storage area 151 is a memory area allocated in a memory and allocated for storing the backup image data copied by the backup unit 150.

If the synthetic method selector 120 selects the simple synthesis as the synthetic method, the synthesizer 160 generates synthesized image data by copying the difference image data stored in the difference image storage area 132 to a integrated position in the entire image area under control of software. That is, in this case, the synthesizer 160 functions as an image data synthesizer. In this embodiment, the entire image data is synthesized as a first image data, and the difference image data is synthesized as a second image data.

In this embodiment, the image processing apparatus includes the backup unit 150 and the synthesizer 160 separately. However, it is possible that the synthesizer 160 includes the function of the backup unit 150.

If the synthesized image data is generated using the simple synthesis, the synthesizer 160 synthesizes the image data under control of software. By contrast, if the synthesized image data is generated using the direct write-in synthesis, the image decoder 130 synthesizes the image data under control of not software but hardware.

As a result, processing speed of synthesizing image data using the direct write-in synthesis by the image decoder 130 is faster than processing speed of synthesizing image data by the synthesizer 160. In addition, processing load of synthesizing image data using the direct write-in synthesis by the image decoder 130 is lighter than processing speed of synthesizing image data by the synthesizer 160.

The image output unit 170 reads the synthesized image data stored in the entire image storage area 131 and outputs an image in accordance with the read synthesized image data.

The audio decoder 180 decodes compressed audio data input from the demultiplexer 110. The audio output unit 181 outputs audio in accordance with the audio data decoded by the audio decoder 180.

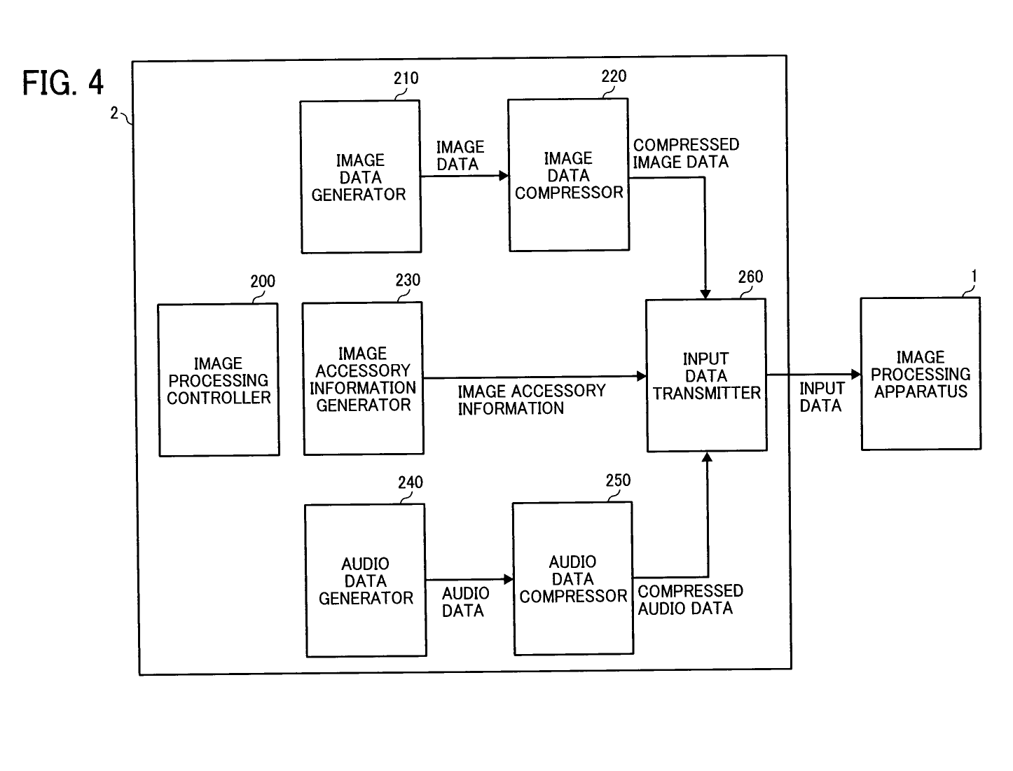

Next, a functional configuration of the information processing apparatus 2 in this embodiment is described below with reference to FIG. 4. FIG. 4 is a block diagram illustrating a functional configuration of the information processing apparatus 2.

As shown in FIG. 4, the information processing apparatus 2 in this embodiment includes an image processing controller 200, an image data generator 210, an image data compressor 220, an image accessory information generator 230, an audio data generator 240, an audio data compressor 250, and an input data transmitter 260.

The information processing controller 200 controls various units included in the information processing apparatus 2 and gives commands to those units included in the information processing apparatus 2. The image data generator 210 generates the difference image data and the entire image data. The image data compressor 220 generates compressed image data by compressing the difference image data and the entire image data generated by the image data generator 210. The image accessory information generator 230 generates the image accessory information.

The audio data generator 240 generates the audio data. The audio data compressor 250 generates the compressed audio data by compressing the audio data generated by the audio data generator 240.

The input data transmitter 260 transfers input data including the compressed image data generated by the image data compressor 220, the image accessory information generated by the image accessory information generator 230, and the compressed audio data generated by the audio data compressor 250 to the image processing apparatus 1.

Next, alignment restriction of the image decoder 130 in this embodiment is described below. While operation covering image data of 1 byte per 1 pixel is described below, the case is not limited to that. In addition, while operation covering the horizontal direction of the image data is described below, the case is not limited to that. In addition, while a memory that can store data of 1 byte per 1 address, the case is not limited to that. In addition, while an alignment value of a hardware decoder is 16 bytes is described below, the case is not limited to that.

Generally speaking, in case of writing data in a memory, a hardware decoder cannot use an arbitrary memory area, and a hardware decoder only can use a memory area whose byte width is assured considering an alignment value of the hardware decoder. That is, the hardware decoder only can write data in a memory area that complies with the alignment restriction. Consequently, in case of writing data in a memory by the hardware decoder, it is required that a memory address considering the alignment value of the hardware decoder is specified preliminarily.

For example, the image decoder 130 is a hardware decoder whose alignment value is 16 bytes in the horizontal direction. In case of writing image data of 1 byte per pixel in a memory, the image decoder 130 can only use the memory area whose byte width is in units of 16 bytes in the horizontal direction. That is, in this case, the image decoder 130 can only use the memory area whose byte width is multiples of 16 bytes in the horizontal direction.

In addition, generally speaking, in case of writing data in a memory, a hardware decoder cannot use an arbitrary number of bytes in the horizontal direction of the data, and the hardware decoder only can write data with the number of bytes considering the alignment value of the hardware decoder. That is, the hardware decoder only can write data that complies with the alignment restriction in a memory.

For example, the image decoder 130 is a hardware decoder whose alignment value is 16 bytes in the horizontal direction. In case of writing 1 byte per 1 pixel in a memory, the image decoder 130 only can write image data that is multiples of 16 bytes in the horizontal direction in a memory.

However, the number of bytes of image data in the horizontal direction is not always multiples of 16 bytes. As a result, in order to fill in bytes to reach multiples of 16 bytes, the image decoder 130 decodes the compressed image data to make it multiples of 16 bytes by adding invalid data included in the compressed image data to the image data.

For example, if the number of bytes of image data in the horizontal direction is 499 bytes, the image decoder 130 makes it multiples of 16 bytes by adding invalid data of 13 bytes to the image data (i.e., 499 bytes+13 bytes=16 bytes*32).

As a result, if the image decoder 130 integrates the difference image data with the entire image data using the direct write-in synthesis, the invalid data is also integrated.

To cope with this issue, if the number of bytes of image data in the horizontal direction is not multiples of 16 bytes, the image processing apparatus 1 in this embodiment saves data located at a position corresponding to invalid data by copying it from the entire image data to the backup image storage area 151 as backup image data.

Accordingly, after synthesizing the image data, the image processing apparatus 1 in this embodiment writes back the backup image data saved in the backup image storage area 151 in its original address. The backup synthesis in this embodiment is described above.

Other than that, if the hardware decoder performs JPEG compression on the image data, since compression unit is 8 pixels vertically by 8 pixels horizontally, it is required that the number of bytes of the image data in the horizontal direction is 8 bytes.

If the hardware decoder compresses color image data using 4:2:0 format, since 1 block of color difference component corresponds to 4 blocks of brightness component (2 blocks vertically by 2 blocks horizontally), it is required that the number of bytes of the image data in the horizontal direction is 16 bytes.

In addition, generally speaking, in case of writing data in a memory, a hardware decoder cannot use an arbitrary address in the horizontal direction in a memory area, and the hardware decoder only can write data in an address considering the alignment value of the hardware decoder. That is, the hardware decoder only can write data in an address that complies with the alignment restriction.

For example, the image decoder 130 is a hardware decoder whose alignment value is 16 bytes in the horizontal direction. In case of writing 1 byte per 1 pixel in a memory, the image decoder 130 only can write the image data in an address that is multiples of 16 bytes from an end in the horizontal direction in a memory.

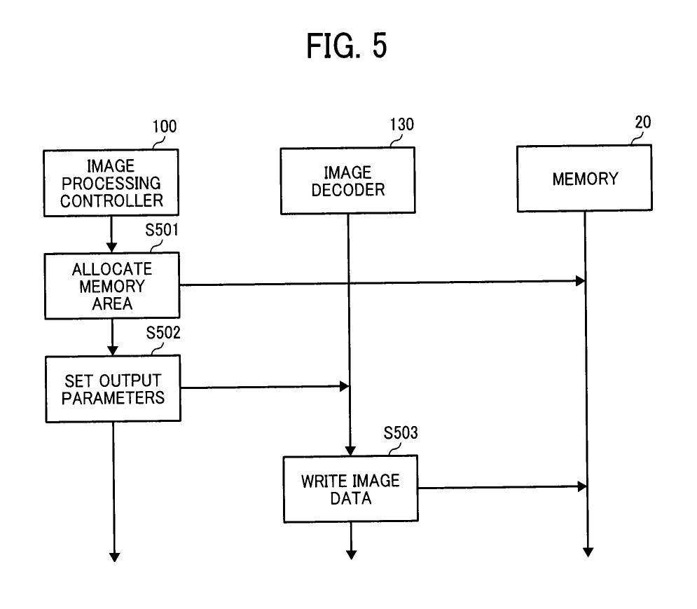

Next, operation that the image decoder 130 in this embodiment writes image data in a memory is described below with reference to FIG. 5. FIG. 5 is a sequence diagram illustrating operation that the image decoder 130 writes image data in a memory in this embodiment.

As shown in FIG. 5, when the image decoder 130 in this embodiment writes image data in a memory, first, the image processing controller 100 allocates a memory area with a byte width considering the alignment value of the image decoder 130 in the memory in S501.

Here, the byte width of the memory area allocated by the image processing controller 100 is equal to or more than the number of bytes of the image data in the horizontal direction and multiples of the alignment value of the image decoder 130 in the horizontal direction.

For example, if the number of bytes of image data in the horizontal direction in 499 bytes and the alignment value of the image decoder 130 in the horizontal direction is 16 bytes, the image processing controller 100 allocates the memory area whose memory width is 512 bytes, 528 bytes, or 544 bytes etc.

Next, the image processing controller 100 sets output parameters such as the vertical resolution of the image data, the horizontal resolution of the image data, the byte width of the allocated memory area, the top address of the allocated memory area, and the image format etc. to the image decoder 130 in S502.

After that, in S503, the image decoder 130 writes the image data in the memory area allocated in S501 in accordance with the output parameters configured in S502.

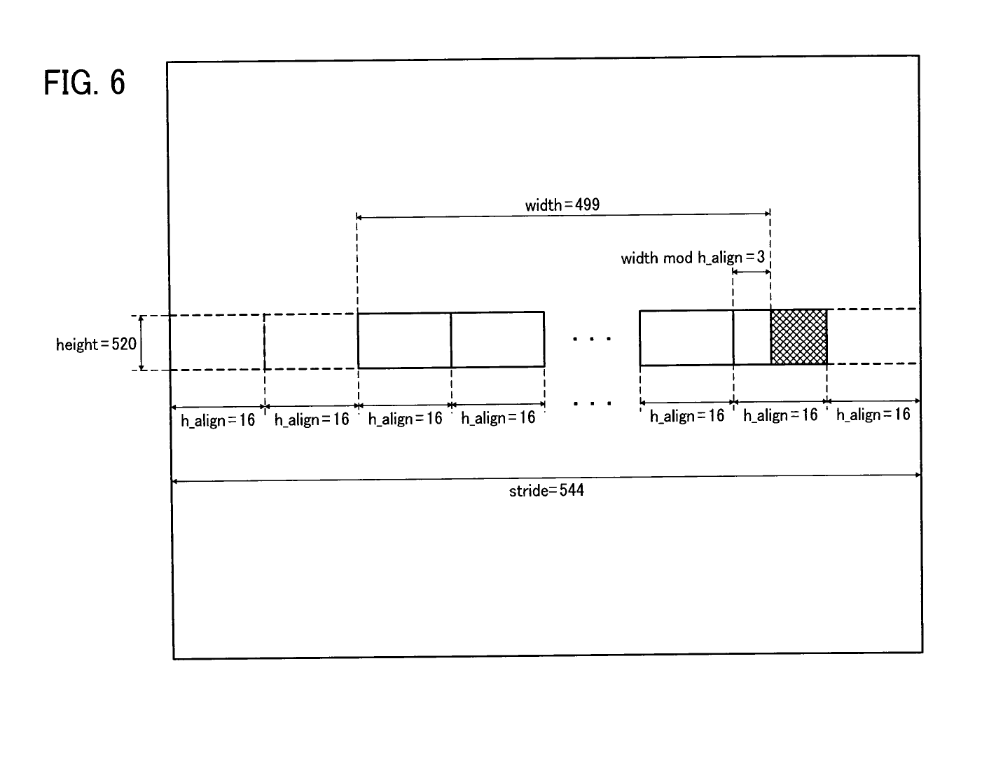

Next, a data structure of the image data written by the image decoder 130 in this embodiment in a memory is described below with reference to FIG. 6. FIG. 6 is a diagram illustrating a data structure of the image data in the memory that the image decoder 130 writes in this embodiment.

In FIG. 6, the horizontal resolution of the image data (the number of bytes) is indicated by width, the vertical resolution of the image data (the number of bytes) is indicated by height, the byte width of the allocated memory area is indicated by stride, and the alignment value of the image decoder 130 is indicated by h_align.

In addition, in FIG. 6, it is assumed that width equals 499, height equals 520, stride equals 544, and h_align equals 16. In FIG. 6, the invalid data is indicated by shading.

Next, operation that the image processing apparatus 1 in this embodiment synthesizes image data using the direct write-in synthesis is described below with reference to FIG. 7. FIG. 7 is a sequence diagram illustrating operation that the image processing apparatus 1 synthesizes image data using the direct write-in synthesis in this embodiment.

As shown in FIG. 7, when the image processing apparatus 1 in this embodiment synthesizes image data using the direct write-in synthesis, first, the output area determination unit 140 determines the entire image storage area 131 as the writing destination of the difference image data based on the synthetic method input by the synthetic method selector 120 in S701.

Next, based on the image accessory information input from the synthetic method selector 120, the output area determination unit 140 determines the top address of the destination where the image decoder 130 writes the difference image data in the entire image storage area 131 and sets the top address to the image decoder 130 in S702.

In this case, if the synthetic position included in the image accessory information is (horizontal direction, vertical direction)=(h_align, Y), the output area determination unit 140 determines the top address of the writing destination as (h_align, Y). Subsequently, the image processing controller 100 allocates a memory area based on the top address and sets the output parameters to the image decoder 130 as described previously with reference to FIG. 5.

Next, the image decoder 130 writes the decoded difference image data at the synthetic position in the entire image storage area 131 directly in accordance with the set top address and the configured output parameters in S703. As a result, the synthesized image data is generated using the direct write-in synthesis.

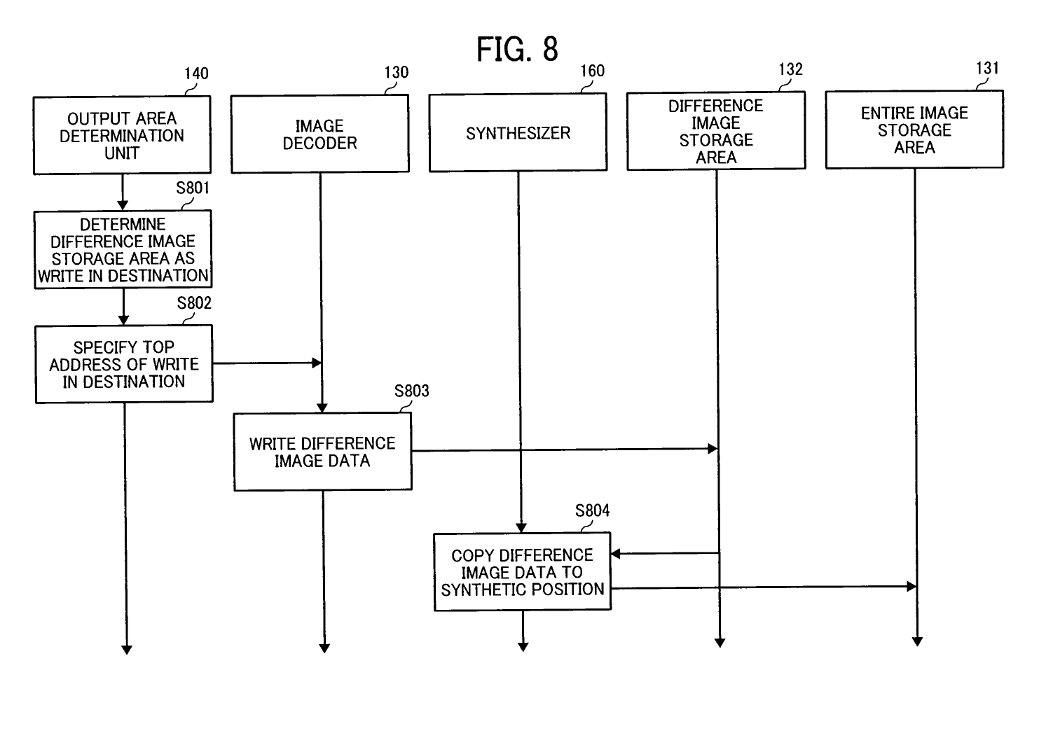

Next, operation that the image processing apparatus 1 in this embodiment synthesizes image data using the simple synthesis is described below with reference to FIG. 8. FIG. 8 is a sequence diagram illustrating operation that the image processing apparatus 1 synthesizes image data using the simple synthesis in this embodiment.

As shown in FIG. 7, when the image processing apparatus 1 in this embodiment synthesizes image data using the simple synthesis, first, the output area determination unit 140 determines the difference image storage area 132 as the writing destination of the difference image data based on the synthetic method input by the synthetic method selector 120 in S801.

Next, based on the image accessory information input from the synthetic method selector 120, the output area determination unit 140 determines the top address of the destination where the image decoder 130 writes the difference image data in the difference image storage area 132 and sets the top address to the image decoder 130 in S802.

In this case, it is possible that the output area determination unit 140 determines an arbitrary address in the difference image storage area 132 as the top address of the writing destination, and it is possible that the output area destination unit 140 determines the top address in the difference image storage area 132 as the top address of the writing destination. Subsequently, the image processing controller 100 allocates a memory area based on the top address and sets the output parameters to the image decoder 130 as described previously with reference to FIG. 5.

Next, the image decoder 130 writes the decoded difference image data in the difference image storage area 132 in accordance with the set top address and the configured output parameters in S803.

Next, based on the integrated position input from the output area determination unit 140, the synthesizer 160 copies the difference image data stored in the difference image storage area 132 to the integrated position in the entire image storage area 131 under control of software in S804. As a result, the synthesized image data is generated using the simple synthesis.

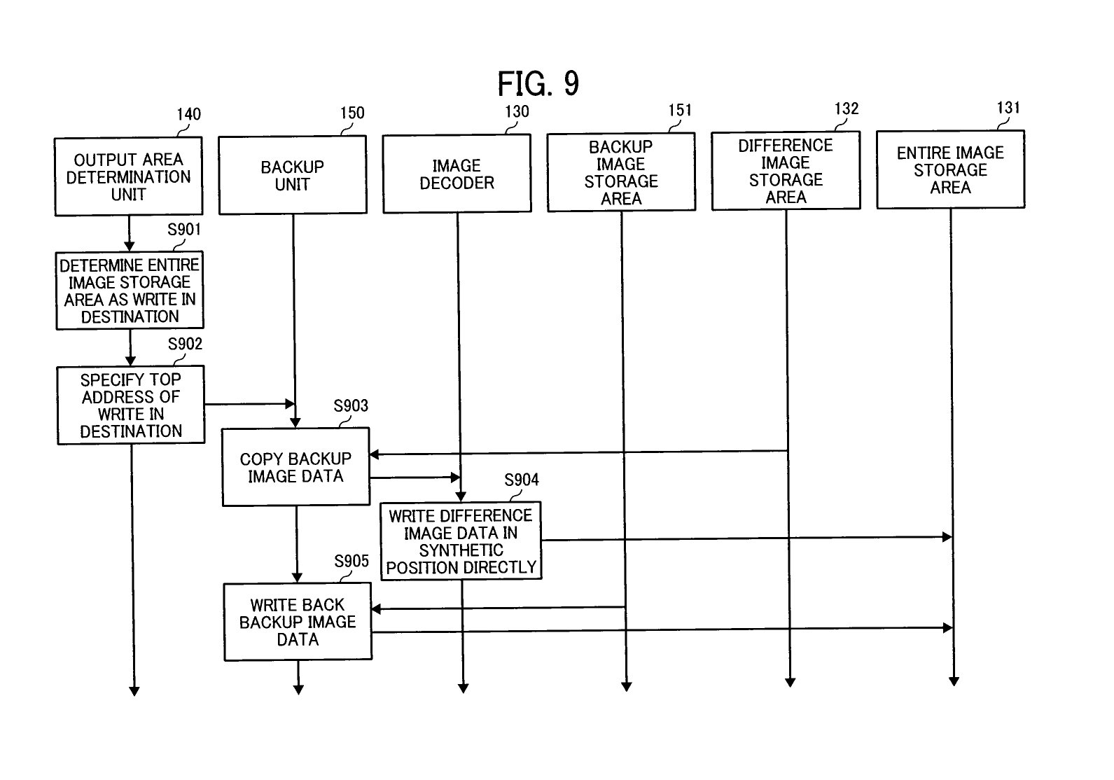

Next, operation that the image processing apparatus 1 in this embodiment synthesizes image data using the backup synthesis is described below with reference to FIG. 9. FIG. 9 is a sequence diagram illustrating operation that the image processing apparatus 1 synthesizes image data using the backup synthesis in this embodiment.

As shown in FIG. 9, when the image processing apparatus 1 in this embodiment synthesizes image data using the backup synthesis, first, the output area determination unit 140 determines the entire image storage area 131 as the writing destination of the difference image data based on the synthetic method input by the synthetic method selector 120 in S901.

Next, based on the image accessory information input from the synthetic method selector 120, the output area determination unit 140 determines the top address of the destination where the image decoder 130 writes the difference image data in the entire image storage area 131 and sets the top address to the image decoder 130 in S902.

In this case, if the synthetic position included in the image accessory information is (horizontal direction, vertical direction)=(h_align, Y), the output area determination unit 140 determines the top address of the writing destination as (h_align, Y). Subsequently, the image processing controller 100 allocates a memory area based on the top address and sets the output parameters to the image decoder 130 as described previously with reference to FIG. 5.

Next, based on the backup position input from the output area determination unit 140, the backup unit 150 saves data located at a position corresponding to invalid data by copying it from the entire image data to the backup image data storage area 151 as the backup image data in S903.

Next, the image decoder 130 writes the decoded difference image data at the synthetic position in the entire image storage area 131 directly in accordance with the set top address and the configured output parameters in S904.

Next, the backup unit 150 writes back the backup image data stored in the backup image storage area 151 to the entire image storage area 131 under control of software in S905. As a result, the synthesized image data is generated using the backup synthesis.

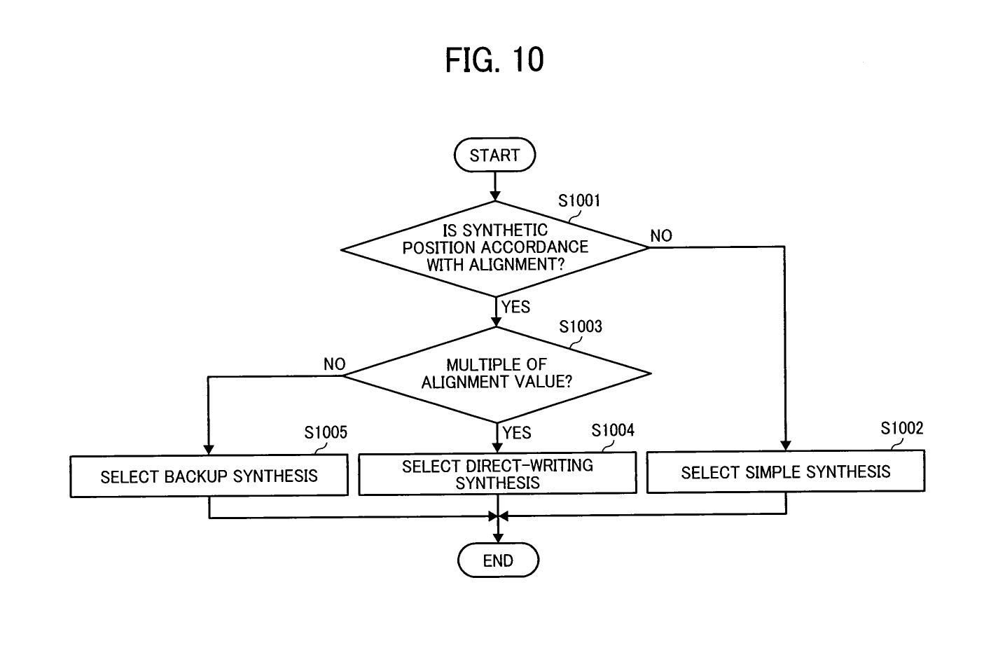

Next, operation that the image processing apparatus 1 in this embodiment selects the synthetic method is described below with reference to FIG. 10. FIG. 10 is a flowchart illustrating operation that the image processing apparatus selects a synthesizing method in this embodiment.

As shown in FIG. 10, when the image processing apparatus 1 in this embodiment selects the synthetic method, first, the synthetic method selector 120 determines whether or not the integrated position in the horizontal direction complies with the alignment restriction of the image decoder 130 based on the image accessory information input from the demultiplexer 110 in S1001.

If it is determined that the integrated position does not comply with the alignment restriction of the image decoder 130 (NO in S1001), since the image decoder 130 cannot write the difference image data in the entire image area directly, the synthetic method selector 120 selects the simple synthesis as the synthetic method in S1002.

As a result, even if the integrated position does not comply with the alignment of the image decoder 130, since the image processing apparatus 1 in this embodiment can integrates the difference image data on the appropriate position under control of software, it is possible to keep image quality of the synthesized image.

By contrast, if it is determined that the integrated position complies with the alignment restriction of the image decoder 130 (YES in S1001), the synthetic method selector 120 determines whether or not the horizontal resolution of the difference image data is multiples of the alignment value based on the image accessory information input from the demultiplexer 110 in S1003.

If the image decoder is the hardware decoder that the horizontal resolution of the difference image data always corresponds with multiples of the alignment value, the synthetic method selector 120 do not need to perform the determination step in S1003, and the process proceeds to S1004.

If it is determined that the horizontal resolution of the difference image data is multiples of the alignment value (YES in S1003), since the invalid data is not added to the difference image data, the direct write-in synthesis is selected as the synthetic method in S1004.

As described above, in the image processing apparatus 1 in this embodiment, if the horizontal resolution of the difference image data is multiples of the alignment value, it is possible to perform the synthesizing operation under control of not software but hardware. As a result, the image processing apparatus 1 in this embodiment can perform the synthesizing operation faster than the simple synthesis, and it is possible to reduce the processing load of the synthesizing operation compared to the simple synthesis.

By contrast, if it is determined that the horizontal resolution of the difference image data is not multiples of the alignment value (NO in S1003), since the invalid data is added to the difference image data, the backup synthesis is selected as the synthetic method in S1005.

As described above, in the image processing apparatus 1 in this embodiment, if the horizontal resolution of the difference image data is not multiples of the alignment value, since the invalid data is not reflected on the synthesized image, it is possible to enhance the image quality of the synthesized image.

In addition, in the image processing apparatus 1 in this embodiment, if the horizontal resolution of the difference image data is not multiples of the alignment value, it is possible to perform the synthesizing operation under control of not software but hardware. As a result, the image processing apparatus 1 in this embodiment can perform the synthesizing operation faster than the simple synthesis, and it is possible to reduce the processing load of the synthesizing operation compared to the simple synthesis.

As described above with reference to FIG. 10, the image processing apparatus 1 in this embodiment selects the most appropriate synthetic method in accordance with the difference image data. Therefore, the image processing apparatus 1 in this embodiment can perform the low-load synthesizing operation of the image data at high speed and synthesize the image data appropriately.

### Embodiment 2

In the embodiment 1 described above, the image processing apparatus 1 that selects the most appropriate synthetic method among the direct write-in synthesis, the simple synthesis, and the backup synthesis in accordance with the difference image data is described. In addition, in the embodiment 1, among those synthetic methods, the direct write-in synthesis can perform the synthesizing operation at the highest speed since the software control is unnecessary, and it is possible to reduce the load of the synthesizing operation.

As a result, if the information processing apparatus 2 can generate the difference image data so that the image processing apparatus 1 can perform the synthesizing operation using the direct write-in synthesis, it is possible to speed up the synthesizing operation by the image processing apparatus 1 and reduce the load of the synthesizing operation.

Therefore, the image processing apparatus 1 in this embodiment instructs the information processing apparatus 2 to generate the difference image data so that it is possible to perform the synthesizing operation using the direct write-in synthesis. Consequently, the image processing apparatus 1 in this embodiment can perform the synthesizing operation at lower load at high speed.

The embodiment is described below in detail with reference to figures. Same symbols are assigned to components corresponding to the embodiment 1, and those descriptions are omitted.

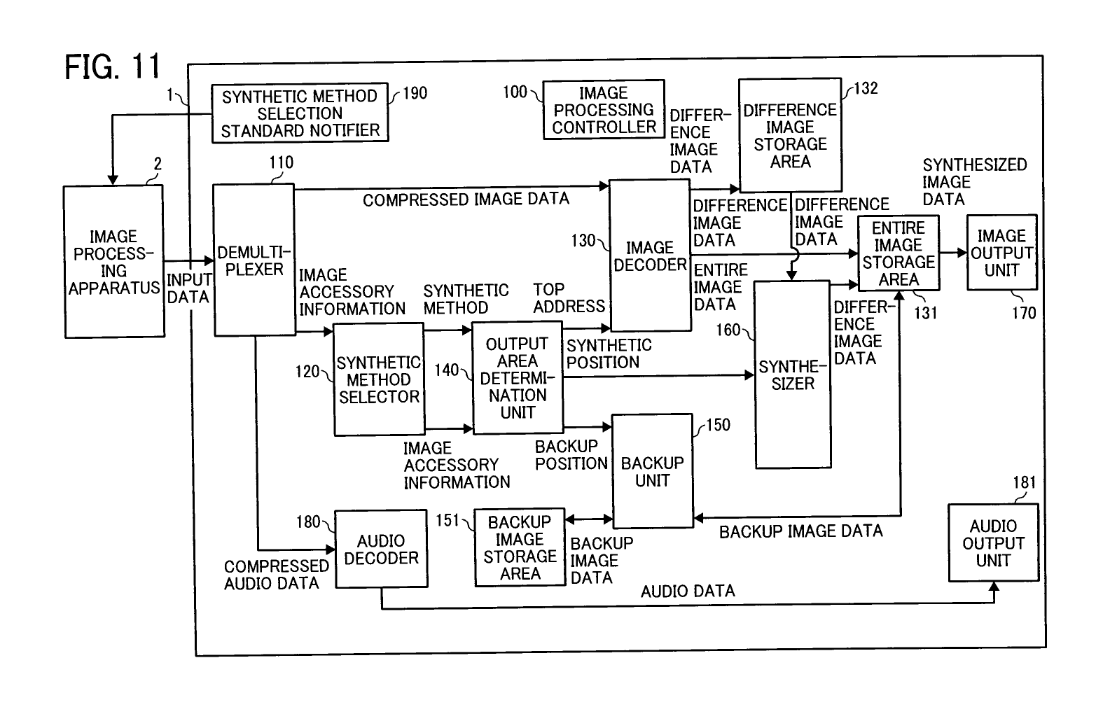

First, a functional configuration of the image processing apparatus 1 in this embodiment is described below with reference to FIG. 11. FIG. 11 is a block diagram illustrating a functional configuration of the image processing apparatus 1.

As shown in FIG. 11, the image processing apparatus 1 in this embodiment further includes a synthetic method selection standard notifier 190. The synthetic method selection standard notifier 190 notifies synthetic method selection standard that is information regarding the alignment restriction of the image decoder 130 to the information processing apparatus 2 so that it is possible to perform the synthesizing operation using the direct write-in synthesis. The synthetic method selection standard is a standard that the synthetic method selector 120 uses for selecting the synthetic method.

Since the information processing apparatus 2 generates the difference image data in accordance with the synthetic method selection standard notified by the image processing apparatus 1, the image processing apparatus 1 can perform the synthesizing operation using the direct write-in synthesis.

As described above, the image processing apparatus 1 notifies the information processing apparatus 2 of the synthetic method selection standard that is the information regarding the alignment restriction of the image decoder 130, and the information processing apparatus 2 generates the difference image data so that it is possible to perform the synthesizing operation using the direct write-in synthesis. Consequently, the image processing apparatus 1 in this embodiment can perform the synthesizing operation at lower load at high speed.

If multiple image processing apparatuses 1 display the same image simultaneously, since the hardware configuration of the image decoder 130 is different in each image processing apparatus 1, it is required to generate multiple difference image data for each of the multiple image processing apparatuses 1, degrading efficiency.

To cope with this issue, the information processing apparatus 2 in this embodiment generates the difference image data so that common multiple of the alignment value of each of the multiple image processing apparatus 1 complies with the alignment restriction based on the synthetic method selection standard notified by the image processing apparatus 1.

If the multiple image processing apparatuses 1 display the same image simultaneously, the information processing apparatus 2 in this embodiment generates only one difference image data, and it is possible that all of the multiple image processing apparatuses 1 perform the synthesizing operation using the direct write-in synthesis.

In the case described above, while the information processing apparatus 2 is required to generate the difference image data as described above, since transfer rate of the image data is limited to the image processing apparatus 1 whose transfer rate is the slowest, it is possible that the information processing apparatus 2 generates the difference image data with reference to the synthetic method selection standard of the slowest image processing apparatus 1.

In this embodiment, the image processing apparatus 1 notifies the information processing apparatus 2 of the synthetic method selection standard that is the information regarding the alignment restriction of the image decoder 130, and the information processing apparatus 2 generates the difference image data so that it is possible to perform the synthesizing operation using the direct write-in synthesis.

Other than that, it is possible that the image processing apparatus 1 in this embodiment modifies the synthetic method selection standard so that it is possible to perform the synthesizing operation using one of the direct write-in synthesis, the simple synthesis, and the backup synthesis depending on the situation.

Numerous additional modifications and variations are possible in light of the above teachings. It is therefore to be understood that, within the scope of the appended claims, the disclosure of this patent specification may be practiced otherwise than as specifically described herein.

The computer software can be provided to the programmable device using any storage medium or carrier medium for storing processor-readable code such as a floppy disk, a compact disk read only memory (CD-ROM), a digital versatile disk read only memory (DVD-ROM), DVD recording only/rewritable (DVD-R/RW), electrically erasable and programmable read only memory (EEPROM), erasable programmable read only memory (EPROM), a memory card or stick such as USB memory, a memory chip, a mini disk (MD), a magneto optical disc (MO), magnetic tape, a hard disk in a server, a solid state memory device or the like, but not limited these. The hardware platform includes any desired kind of hardware resources including, for example, a central processing unit (CPU), a random access memory (RAM), and a hard disk drive (HDD). It is also possible to download the program from an external apparatus that includes a storage medium storing the program or stores the program in a storage unit and install the program in the computer to execute the program. The CPU may be implemented by any desired kind of any desired number of processors. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

In the above-described example embodiment, a computer can be used with a computer-readable program, described by object-oriented programming languages such as C++, Java (registered trademark), JavaScript (registered trademark), Pert, Ruby, or legacy programming languages such as machine language, assembler language to control functional units used for the apparatus or system. For example, a particular computer (e.g., personal computer, workstation) may control an information processing apparatus or an image processing apparatus such as image forming apparatus using a computer-readable program, which can execute the above-described processes or steps. In the above-described embodiments, at least one or more of the units of apparatus can be implemented as hardware or as a combination of hardware/software combination.

Each of the functions of the described embodiments may be implemented by one or more processing circuits. A processing circuit includes a programmed processor, as a processor includes circuitry. A processing circuit also includes devices such as an application specific integrated circuit (ASIC) and conventional circuit components arranged to perform the recited functions.

1. An image processing apparatus, comprising:
an encoded image data acquisition unit to acquire encoded image data;
an image data decoder to decode the encoded image data;
a decoded image storage controller to store the decoded image data in a memory;
an image accessory information acquisition unit to acquire image accessory information including an integrated position where a first image data stored in the memory is integrated with a second image data acquired and decoded after the first image data is acquired;
a synthetic method selector to select a synthetic method to integrate the first image data with the second image data based on the acquired image accessory information and an alignment restriction of the image data decoder; and
an image data synthesizer to integrate the first image data with the second image data in the memory using the selected synthetic method.

2. The image processing apparatus according to claim 1, wherein the synthetic method selector determines whether or not the integrated position complies with the alignment restriction, and the image data synthesizer integrates the first image data with the second image data under control of hardware if it is determined that the integrated position complies with the alignment restriction.

3. The image processing apparatus according to claim 2, wherein the decoded image storage controller stores the second image data in the memory if it is determined that the integrated position does not comply with the alignment restriction, and the image data synthesizer integrates the first image data with the second image data under control of software if it is determined that the integrated position does not comply with the alignment restriction.

4. The image processing apparatus according to claim 2, wherein the image accessory information includes a component on a predetermined direction of the second image data, the synthetic method selector determines whether or not the component complies with the alignment restriction if it is determined that the integrated position complies with the alignment restriction, and the image data synthesizer integrates the first image data with the second image data under control of hardware if it is determined that the component complies with the alignment restriction.

5. The image processing apparatus according to claim 4, further comprising a partial image storage controller to store a predetermined part of the first image data in the memory,
wherein the partial image storage controller stores the predetermined part of the first image data in the memory if it is determined that the component does not comply with the alignment restriction, and the image data synthesizer writes the predetermined part of the first image data stored in the memory in an original position in the first image data after integrating the first image data with the second image data under control of hardware if it is determined that the component does not comply with the alignment restriction.

6. The image processing apparatus according to claim 1, further comprising a synthetic method selection standard notifier to notify the information processing apparatus that generates the second image data of a standard that the synthetic method selector uses for selecting the synthetic method.

7. An image processing system, comprising an information processing apparatus and an image processing apparatus,
the information processing apparatus includes a transmitter to transmit an encoded image data to the image processing apparatus, and
the image processing apparatus includes:
an encoded image data acquisition unit to acquire the encoded image data;
an image data decoder to decode the encoded image data;
a decoded image storage controller to store the decoded image data in a memory;
an image accessory information acquisition unit to acquire image accessory information including an integrated position where a first image data stored in the memory is integrated with a second image data acquired and encoded after the first image data is acquired;
a synthetic method selector to select a synthetic method of integrating the first image data with the second image data based on the acquired image accessory information and an alignment restriction of the image data decoder; and
an image data synthesizer to integrate the first image data with the second image data in the memory using the selected synthetic method.

8. A non-transitory, computer-readable recording medium storing a program that, when executed by one or more processors of an image processing apparatus, causes the processors to implement a method of processing an image, comprising:
acquiring encoded image data;
decoding the encoded image data;
storing the decoded image data in a memory;
acquiring image accessory information including an integrated position where a first image data stored in the memory is integrated with a second image data acquired and decoded after the first image data is acquired;
selecting a synthetic method of integrating the first image data with the second image data based on the acquired image accessory information and an alignment restriction in the decoding step; and
integrating the first image data with the second image data in the memory using the selected synthetic method.
